(19) United States
(12) Patent Application Publication
(10) Pub. No.: US 2024/0027014 A1
(43) Pub. Date: Jan. 25, 2024

(54) INSULATING MATERIAL FOR AEROSOL GENERATING DEVICE AND AEROSOL GENERATING DEVICE INCLUDING THE SAME

(71) Applicant: KT&G CORPORATION, Daejeon (KR)

(72) Inventors: Jong Seong JEONG, Sejong (KR); Gyoung Min GO, Daejeon (KR); Hyung Jin BAE, Daejeon (KR); Jang Won SEO, Daejeon (KR); Chul Ho JANG, Bucheon-si (KR); Jin Chul JUNG, Daejeon (KR)

(73) Assignee: KT&G CORPORATION, Daejeon (KR)

(21) Appl. No.: 18/265,548

(22) PCT Filed: Jul. 26, 2022
(86) PCT No.: PCT/KR2022/010941

§ 371 Date: Jun. 6, 2023

(30) Foreign Application Priority Data
Jul. 29, 2021 (KR) 10-2021-0100146
Dec. 28, 2021 (KR) 10-2021-0190409

(51) Int. Cl. F16L 59/02; A24F 40/20; A24F 40/46

(52) U.S. Cl. CPC F16L 59/026; A24F 40/20; A24F 40/46

(57) ABSTRACT

An insulating material for an aerosol generating device includes an insulation sheet and a waterproof film arranged on at least one surface of the insulation sheet.

### TECHNICAL FIELD

Embodiments relate to an insulating material for an aerosol generating device and an aerosol generating device including the same.

### BACKGROUND ART

Recently, the demand for alternative methods to overcome the disadvantages of traditional cigarettes has increased. For example, there is growing demand for an aerosol generating device which generates aerosol by heating an aerosol generating material, rather than by combusting cigarettes. Accordingly, researches on a heating-type aerosol generating device has been actively conducted.

In some heating-type aerosol generating devices, an insulating material is used as a solution to increase the energy efficiency by preventing heat generated from a heater from being transferred to the outside.

### DISCLOSURE OF INVENTION

### Technical Problem

Insulating materials including cerakwool, aerogel, and the like are used in aerosol generating devices in the related art. As these insulating materials absorb the liquefied sidestream smoke in the aerosol generating device, the thermal conductivity of the insulating materials gradually increases, and eventually, the insulating materials lose their insulating function.

The technical problem of the embodiments is not limited to the aforementioned problem, and other unmentioned problems may be clearly understood by those of ordinary skill in the art in the technical field according to the present specification and the accompanying drawings.

### Solution to Problem

The embodiments provide an insulating material for an aerosol generating device and a method of manufacturing the same, the insulating material having an extraordinary insulation effect and preventing a decrease in the insulation performance due to absorption of liquefied sidestream smoke in the aerosol generating device.

According to an embodiment, an insulating material for an aerosol generating device includes an insulation sheet and a waterproof film arranged on at least one surface of the insulation sheet.

According to another embodiment, an aerosol generating device includes an accommodating space into which an aerosol generating article is inserted, a heater configured to heat the aerosol generating article accommodated in the accommodating space, and an insulating material arranged outside the heater and configured to prevent heat generated from the heater from being transferred to outside of the accommodating space, wherein the insulating material includes an insulation sheet and an insulation film arranged on at least one surface of the insulation sheet.

Technical solutions are not limited thereto, and may include all the matters that may be derived by those of ordinary skill in the art throughout the present specification.

### Advantageous Effects of Invention

According to embodiments, an insulating material for an aerosol generating device and an aerosol generating device including the same may have an extraordinary insulation effect. Also, liquefied sidestream smoke in the aerosol generating device may be prevented from being absorbed to the insulating material, thereby continuously maintaining the extraordinary insulation performance.

Advantageous effects of the embodiments are not limited to the aforementioned description, and may include any effects that may be derived from the configurations to be described hereinafter.

### BRIEF DESCRIPTION OF DRAWINGS

FIG. 1 is a schematic cross-sectional view of an example of an insulating material for an aerosol generating device according to an embodiment;

FIG. 2 is a schematic cross-sectional view of an example of an aerosol generating device including an insulating material for an aerosol generating device according to an embodiment;

FIG. 3 is a cross-sectional view of an example in which an aerosol generating article is inserted into the aerosol generating article according to the embodiment shown in FIG. 2;

FIG. 4 is a schematic cross-sectional view of an aerosol generating device including an insulating material for an aerosol generating device according to another embodiment;

FIGS. 5A and 5B are images of an insulating material of an aerosol generating device, manufactured according to an embodiment;

FIG. 5C is a microscopic image of an outer surface of the insulating material for the aerosol generating device, manufactured according to an embodiment;

FIGS. 6 to 8 are graphs of results of measuring temperature changes according to time to measure the insulation performance of the insulating material for the aerosol generating device according to an embodiment;

FIGS. 9A and 9B are images taken immediately after glycerin droplets are dropped on a surface of the insulating material for the aerosol generating device according to an embodiment;

FIGS. 10A and 10B are images taken an hour after glycerin droplets are dropped on the surface of the insulating material for the aerosol generating device according to an embodiment;

FIG. 11 is a schematic diagram of an example of an aerosol generating article;

FIG. 12 is a schematic diagram of another example of an aerosol generating article; and

FIG. 13 is a schematic diagram of another example of an aerosol generating article.

### BEST MODE FOR CARRYING OUT THE INVENTION

According to an embodiment, an insulating material for an aerosol generating device includes an insulation sheet and a waterproof film arranged on at least one surface of the insulation sheet.

The insulation sheet may have a porous structure formed by insulating fibers.

The insulation sheet may include polyimide fiber.

The insulation sheet may have a thickness of about 0.05 mm to about 1 mm.

The waterproof film may include a first waterproof film arranged on a surface of the insulation sheet and a second waterproof film arranged on another surface of the insulation sheet, wherein the first waterproof film and the second waterproof film may be attached to each other such that the insulation sheet is not exposed to the outside.

The waterproof films may include at least one material selected from the group consisting of polyimide (PT), polyether ether ketone (PEEK), polyamide imide (PAI), polyphenylene sulfide (PPS), polyphenylsulfone (PPSU), polysulfone (PSU), polyethersulfone (PES), polyetherimide (PEI), polytetrafluoroethylene (PTFE), and polyvinylidene fluoride (PVDF).

According to another embodiment, an aerosol generating device includes an accommodating space for accommodating an aerosol generating article, a heater configured to heat the aerosol generating article accommodated in the accommodating space, and an insulating material arranged outside the heater and configured to prevent heats generated from the heater from being transferred to outside of the accommodating space, wherein the insulating material includes an insulation sheet and an insulation film arranged on at least one surface of the insulation sheet.

The insulating material may contact an end portion of the heater in a longitudinal direction of the heater.

The insulating material may be arranged between the heater and an outer housing of the aerosol generating device, and the heater and the insulating material may be arranged apart from each other.

The insulation sheet may have a porous structure formed by insulating fibers.

The insulation sheet may include a polyimide fiber.

The insulation sheet may have a thickness of about 0.05 mm to about 1 mm.

The insulating material may further include a first waterproof film arranged on a surface of the insulation sheet and a second waterproof film arranged on another surface of the insulation sheet, wherein the first waterproof film and the second waterproof film may be attached to each other such that the insulation sheet is not exposed to the outside.

The first waterproof film and the second waterproof film may include at least one material selected from the group consisting of polyimide (PI), polyether ether ketone (PEEK), polyamide imide (PAI), polyphenylene sulfide (PPS), polyphenyl sulfone (PPSU), polysufone (PSU), polyether sulfone (PES), polyetherimide (PEI), polytetrafluoroethylene (PTFE), and polyvinylidene fluoride (PVDF).

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In addition, terms including ordinal numbers, such as “first”, “second” used in the present specification, may be used to describe various components, but the components are not limited to the terms. The terms are only used to distinguish one component from other components.

Throughout the specification, “aerosol generating device” may indicate a device configured to generate an aerosol by using an aerosol generating article to generate an aerosol that may be directly inhaled into a lung of a user through the user's mouth.

Throughout the specification, “an aerosol generating article” is an article used for smoking. For example, the aerosol generating article may include a general combustion cigarette that is used in a method of ignition and combustion, or may include a heating type cigarette that is used in a method of being heated by the aerosol generating device. As another example, the aerosol generating article may include an article that is used in a method of heating a liquid included in a cartridge.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

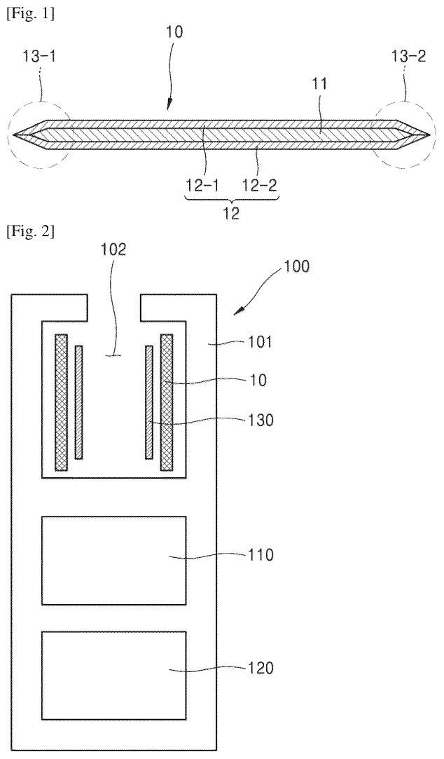

FIG. 1 is a schematic diagram of an example of an insulating material 10 for an aerosol generating device according to an embodiment.

Referring to FIG. 1, the insulating material 10 for the aerosol generating device includes an insulation sheet 11 and a waterproof film 12. However, the embodiment is not limited thereto. For example, in addition to the components shown in FIG. 1, other components may be further included in the insulating material 10 for the aerosol generating device. FIG. 1 illustrates a cross-sectional view of the insulating material 10 for the aerosol generating device where the insulating material 10 which has a plane sheet shape. However, this is merely an example, and the insulating material 10 for the aerosol generating device 10 may have appropriate different shape according to a position at which the insulating material 10 for the aerosol generating device is arranged, use of the insulating material 10, a type of the heater of the aerosol generating device, a shape of the heater of the aerosol generating device, and the like. For example, the insulating material 10 for the aerosol generating article may be selected from among shapes such as a container shape, a cylinder shape, a tube shape, a sheet shape, and the like, but is not limited thereto.

The insulation sheet 11 may include an insulating fiber. The insulating fiber may include at least one material selected from the group consisting of polyimide (PI), polyether ether ketone (PEEK), polyamide imide (PAI), polyphenylene sulfide (PPS), polyphenyl sulfone (PPSU), polysulfone (PSU), polyether sulfone (PES), polyether imide (PET), polytetrafluoroethylene (PTFE), and polyvinylidene fluoride (PVDF). However, the material of the insulating fiber is not limited thereto, and a material having heat resistance at a temperature of a certain level or higher (for example, 300° C. or higher) and having low heat conductivity may be used without limitation.

The insulation sheet 11 prevents transfer of the heat. For example, the insulation sheet 11 may be included in the insulating material 10 for the aerosol generating device and prevent transfer of the heat generated from the heater of the aerosol generating device.

The insulation sheet 11 may include a porous structure formed by an insulating fiber. For example, the porous structure may be implemented by a fabric manufactured using the insulating fiber. The fabric manufactured using the insulating fiber may have extraordinary insulation performance due to fine pores formed among the insulating fibers.

For example, the insulation sheet 11 may include polyimide paper, which is a fabric manufactured using a PI fiber. However, this is merely an example, and a type of the insulating fiber included in the insulation sheet 11 and the porous structure formed in the insulation sheet 11 may be suitably changed.

The insulation sheet 11 may have a thickness of about 0.05 mm to about 1 mm. The insulating material, which includes the fabric manufactured using the insulating fiber, may be manufactured in a small thickness, and therefore, an application range of the manufactured insulating material 10 may increase on the basis of flexibility thereof. When the insulation sheet 11 has a thickness less than about 0.05 mm, the insulation sheet 11 may have less insulation performance and less durability. In addition, when the insulation sheet 11 has a thickness greater than about 1 mm, the flexibility of the insulation sheet 11 may decrease, and a volume of the insulating material 10 excessively increase. Therefore, a range of the insulating material 10 applicable to the aerosol generating device may decrease.

For example, the insulating material 10, which includes the fabric manufactured using the insulating fiber, may have a tube shape surrounding the accommodating space for accommodating the aerosol generating article of the aerosol generating device, which will be described later. As another example, the insulating material 10, which includes the fabric manufactured using the insulating fiber, may be applied to a gasket arranged between the heater of the aerosol generating device and a component configured to support the heater. As for the insulation sheet 11 applied to the gasket, a relatively small thickness is required to secure sufficient flexibility. Therefore, the insulation sheet 11 may have a thickness of from about 0.06 mm to about 0.5 mm, or a thickness of from about 0.08 mm to about 0.4 mm.

The waterproof film 12 may be formed on at least one surface of the insulation sheet 11. The waterproof film 12 may conserve the insulation performance of the insulation sheet 11 by preventing moisture (for example, liquefied sidestream smoke) and air from infiltrating from the outside. Although FIG. 1 illustrates that the waterproof films 12 are arranged on two surfaces of the insulation sheet 11, the embodiment is not limited thereto, and the waterproof film 12 may be arranged only on one surface of the insulation sheet 11 and not on another surface facing the one surface.

Here, the waterproof film 12 may be arranged on the insulation sheet 11 by various methods that keep the insulation sheet 11 and the waterproof film 12 in close contact with each other. For example, the waterproof film 12 may be attached to the insulation sheet 11 by using an adhesive material. As another example, a vacuum may be created between the insulation sheet 11 and the waterproof films 12. As another example, the surface of the insulation sheet 11 may be coated with the waterproof film 12.

The waterproof film 12 may be arranged to prevent the insulation sheet 11 from being exposed to the outside. For example, a first waterproof film 12-1 may be arranged on a surface of the insulation sheet 11, a second waterproof film 12-2 may be arranged on another surface facing the surface of the insulation sheet 11, and the first waterproof film 12-1 and the second waterproof film 12-2 may be attached to each other to prevent the insulation sheet 11 from being exposed to the outside. As shown in FIG. 1, edges 13-1 and 13-2 of the first waterproof film 12-1 and the second waterproof film 12-2 respectively arranged on two surfaces of the insulation sheet 11 may be closed. By doing so, the insulation sheet 11 is not exposed to the outside, and accordingly, permeation of moisture or air from the outside may be prevented.

The waterproof film 12 may include a material having an adhesive force or heat resistance. For example, the waterproof film 12 may include a polymer material having heat resistance at a temperature equal to or higher than 200° C. and having adhesion. For example, the waterproof film 12 may include at least one polymer material selected from the group consisting of PI, PEEK, PAI, PPS, PPSU, PSU, PES, PEI, PTFE, and PVDF.

For example, the waterproof film 12 may include a polyimide film. The polyimide film may prevent moisture absorption and has extraordinary heat resistance. Therefore, a polyimide film may be suitable for the insulating material 10 that is attached to the heater of the aerosol generating device.

The waterproof film 12 may be formed by coating the insulation sheet 11 with varnish having adhesion force and heat resistance. In this case, the insulating material may be manufactured by coating the insulation sheet 11 with the paint and drying the paint, without the process of thermal fusion or compression of the film. Accordingly, the manufacture process may be simplified, and a manufacture cost may be reduced. For example, the waterproof film 12 may be formed by coating the insulation sheet 11 with polyimide varnish. However, embodiments are not limited thereto, and a type of the paint may be appropriately selected in consideration of a type of the insulation sheet 11, use of the insulating material 10, and the like. Here, a varnish indicates a kind of paint used for forming the film.

In addition, when the waterproof film 12 is formed by coating using the varnish, when compared with a case in which the waterproof film 12 is attached to the insulation sheet 11, a film may have a smaller thickness, and the adhesion force of the waterproof film 12 to the insulation sheet 11 may be improved. As the waterproof film 12 is formed in a small thickness, a volume of the insulating material 10 decreases, and at the same time, flexibility of the insulating material 10 may be improved. Accordingly, space utility in the aerosol generating device may be improved, and the insulating material 10 may be used for more various purposes.

For example, the insulating material 10 may be used as a gasket arranged among the components in the aerosol generating device. In addition, the insulating material 10 may be arranged to surround an end portion in a longitudinal direction of a tube-shaped heater in which a hollow is formed, to prevent the end portion of the heater from being exposed to the outside. Mainstream smoke generated in the aerosol generating article is puffed through the user's mouth. Sidestream smoke is generated at an upstream end portion of the aerosol generating article. The sidestream smoke may be liquefied in the aerosol generating device, without being puffed by the user. The liquefied sidestream smoke may be absorbed into the insulating material in the aerosol generating device and degrade the insulation performance of the insulating material. In the insulating material 10 according to an embodiment, the insulating material 10 for the aerosol generating device may prevent the waterproof film 12 may be arranged on the surface of the insulation sheet 11 to prevent absorption of the liquefied sidestream smoke, and accordingly the performance of the insulating material 10 may be maintained. In addition, as the heat of the heater is effectively concentrated onto the aerosol generating article through the insulating material 10 for the aerosol generating device, a flavor of a generated aerosol may be improved, and a pre-heating time and power consumption of the heater may be reduced.

FIG. 2 is a schematic cross-sectional view of an example of the aerosol generating device 100 including the insulating material 10 for the aerosol generating device according to an embodiment.

Referring to FIG. 2, the aerosol generating device 100 may include a battery 110, a controller 120, a heater 130, and the insulating material 10 for the aerosol generating device 100. However, the embodiment is not limited thereto, and in addition to the components shown in FIG. 2, other components may be further included in the aerosol generating device 100. The battery 110, the controller 120, and the heater 130 may be differently arranged according to design of the aerosol generating device 100.

The battery 110 provides power for operation of the aerosol generating device 100. For example, the battery 110 may provide power such that an alternating current may be applied to the heater 130, and may provide power for operation of the controller 120. In addition, the battery 110 may also provide power for operations of a display unit, a sensor, a motor and the like mounted in the aerosol generating device 100.

The controller 120 controls general operations of the aerosol generating device 100. More particularly, the controller 120 controls operations of other configurations included in the aerosol generating device, as well as operations of the battery 110 and the heater 130. In addition, the controller 120 may confirm states of the components of the aerosol generating device 100 to determine whether the aerosol generating device 100 is operable.

The controller 120 may include at least one processor. The processor may be implemented as an array of a plurality of logic gates, and may also be implemented as a combination of a general-purpose microprocessor and a memory configured to store a program executable by the microprocessor. In addition, those skilled in the art may understand that the processor may also be implemented as other types of hardware.

The heater 130 may be heated by the power provided from the battery 110. For example, when the aerosol generating article 200 is inserted into the aerosol generating device 100, the heater 130 may be at the outside of the aerosol generating article 200. Accordingly, the heater 130 that had been heated may increase a temperature of the aerosol generating material in the aerosol generating article.

The heater 130 may include an electrically resistive heater. For example, the heater 130 may include an electrically conductive track, and the heater 130 may be heated as a current flows through the electric conductive track. However, the heater 130 is not limited to the aforementioned example, and may include any type of heater that may be heated to a desired temperature. Here, the desired temperature may be preset in the aerosol generating device 100, and may be set as a desired temperature by the user.

For example, the heater 130 may include a tube-type heating element, a plate-type heating element, a pin-type heating element, or a rod-type heating element, and may heat the inside or outside of the aerosol generating article 200 according to a shape of the heating element.

In addition, a plurality of the heaters 130 may be arranged in the aerosol generating device 100. In this case, the plurality of heaters 130 may be inserted into the aerosol generating article 200, or may be arranged at the outside of the aerosol generating article 200. In addition, from among the plurality of the heaters 130, some may be inserted into the aerosol generating article 200, and others may be arranged at the outside of the aerosol generating article 200. In addition, a shape of the heater 130 is not limited to the shape shown in FIG. 2, and the heater 130 may be manufactured in various shapes.

As another example, the heater 130 may include an induction heater. For example, the heater 130 may include an electrically conductive coil configured to heat the aerosol generating article 200 in an induction method, and the aerosol generating article 200 may include a susceptor that may be heated by the induction heater. The induction method may indicate a method of having a magnetic substance generate heat by applying an alternating magnetic field, which periodically changes directions thereof, to the magnetic substance that generates heat due to an external magnetic field.

When the alternating magnetic field is applied to the magnetic substance, an energy loss due to an eddy current loss and hysteresis loss may occur in the magnetic field, and the lost energy may be emitted as heat energy from the magnetic substance. According to increase in an amplitude or frequency of the alternating magnetic field applied to the magnetic substance, a greater amount of heat energy may be emitted from the magnetic substance. The aerosol generating device 100 may have the magnetic substance have discharge heat energy by applying an alternating magnetic field to the magnetic substance, and may deliver the heat energy, which is emitted from the magnetic substance, to the aerosol generating article 200.

The magnetic substance generating heat due to the external magnetic field may include a susceptor. The susceptor may be provided in the aerosol generating device 100 in the form of a piece, a flake, or a strip. For example, at least a portion of the heater 130 arranged in the aerosol generating device 100 may include a susceptor material.

At least a portion of the susceptor material may include a ferromagnetic substance. For example, the susceptor material may include metal or carbon. The susceptor material may include at least one of ferrite, ferromagnetic alloy, stainless steel, and aluminum (Al). In addition, the susceptor material may include at least one of graphite, molybdenum, silicon carbide, niobium, nickel alloy, a metal film, ceramic such as zirconia, a transition metal such as nickel (Ni) or cobalt (Co), or a metalloid such as boron (B) or phosphorus (P).

The aerosol generating device 100 may accommodate the aerosol generating article 200. An accommodating space 102 for accommodating the aerosol generating article 200 may be formed in the aerosol generating device 100. The heater 130 may be arranged in the space for accommodating the aerosol generating article 200. For example, the heater 130 may include the accommodating space 102, which is cylindrical, to accommodate the aerosol generating article 200 therein. Therefore, when the aerosol generating article 200 is accommodated in the aerosol generating device 100, the aerosol generating article 200 may be accommodated in the accommodating space 102 of the heater 130.

The heater 130 may surround at least a portion of an external surface of the aerosol generating article 200 accommodated in the aerosol generating device 100. For example, the heater 130 may surround a tobacco medium included in the aerosol generating article 200. By doing so, the heat may be more efficiently delivered from the heater 130 to the tobacco medium.

The heater 130 may heat the aerosol generating article 200 accommodated in the aerosol generating device 100. As described above, the heater 130 may heat the aerosol generating article 200 in an induction heating method. The heater 130 may include a susceptor material generating heat due to the external magnetic field, and the aerosol generating device 100 may apply the alternating magnetic field to the heater 130.

Although not shown in FIG. 2, the coil may be provided in the aerosol generating device 100. The coil may apply the alternating magnetic field to the heater 130. When power is provided from the aerosol generating device 100 to the coil, a magnetic field may be formed in the coil. When an alternating current is applied to the coil, a direction of the magnetic field formed in the coil may be continuously changed. When the heater 130 is in the coil and exposed to the alternating magnetic field that periodically changes a direction thereof, the heater 130 may generate heat, and the aerosol generating article 200 accommodated in the accommodating space 102 of the heater 130 may be heated.

The coil may be wound along an outer surface of the heater 130. In addition, the coil may also be wound along an inner surface of an outer housing 101 of the aerosol generating device 100. The heater 130 may be in an inner space formed by wound coils. When power is provided to the coil, the alternating magnetic field generated by the coil may be applied to the heater 130.

The coil may extend in the longitudinal direction of the aerosol generating device 100. The coil may extend to an appropriate length in the longitudinal direction. For example, the coil may extend to a length corresponding to a length of the heater 130, or may extend to a length greater than the length of the heater 130.

The coil may be arranged at a suitable position to apply the alternating magnetic field to the heater 130. For example, the coil may be arranged at a position corresponding to the position of the heater 130. The efficiency of applying the alternating magnetic field of the coil to the heater 130 may be improved due to a size and arrangement of the coil described above.

When an amplitude or a frequency of the alternating magnetic field generated by the coil changes, a degree to which the heater 130 heats the aerosol generating article 200 may also be changed. The amplitude or frequency of the magnetic field generated by the coil may be changed due to the power applied to the coil, and therefore, the aerosol generating device 100 may control heating of the aerosol generating article 200 by adjusting the power applied to the coil. For example, the aerosol generating device 100 may control the amplitude and frequency of an alternating current applied to the coil.

As an example, the coil may be implemented as a solenoid. The coil may include a solenoid wound along the inner surface of the outer housing 101 of the aerosol generating device 100, and the heater 130 and the aerosol generating article 200 may be in an inner space of the solenoid. A wiring of the solenoid may include copper (Cu). However, the material of the solenoid is not limited thereto, and an alloy including any one or at least one of silver (Ag), gold (Au), aluminum (Al), tungsten (W), zinc (Zn), and nickel (Ni) may be the material of the wiring of the solenoid.

Although not shown in FIG. 2, the aerosol generating device 100 may further include a vaporizer. The vaporizer may generate an aerosol by heating a liquid composition, and the aerosol that had been generated may be provided to the user via the aerosol generating article 200. In other words, the aerosol generated by the vaporizer may move along an air flow path of the aerosol generating device 100, and the air flow path may be configured such that the aerosol generated by the vaporizer may be delivered to the user via the aerosol generating article 200.

For example, the vaporizer may include a liquid storage, a liquid delivery element, and a heating element, but it is not limited thereto. For example, the liquid storage, the liquid delivery element, and the heating element may be included in the aerosol generating device as independent modules.

The liquid storage may store a liquid composition. For example, the liquid composition may include a liquid including a tobacco-containing material, which contains a volatile tobacco-flavored ingredient, or a liquid including a non-tobacco material. The liquid storage may be manufactured to be attached to/detached from the vaporizer, and may integrally manufactured with the vaporizer.

For example, the liquid composition may include water, solvent, ethanol, plant extracts, spices, flavorings, or vitamin mixtures. The spices may include menthol, peppermint, spearmint oil, and various fruit-flavored ingredients, but are not limited thereto. The flavorings may include ingredients that may provide various flavors or savors to the user. The vitamin mixture may include a mixture of at least one of vitamin A, vitamin B, vitamin C, and vitamin E, but is not limited thereto. In addition, the liquid composition may include an aerosol forming substance, such as glycerin and propylene glycol.

The liquid delivery element may deliver the liquid composition of the liquid storage to the heating element. For example, the liquid delivery element may include a wick such as cotton fiber, ceramic fiber, glass fiber, or porous ceramic, but is not limited thereto.

The heating element may be configured to heat the liquid composition delivered by the liquid delivery element. For example, the heating element may include a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may deliver heat to the liquid composition in contact with the heating element, thereby heating the liquid composition. As a result, the aerosol may be generated.

For example, the vaporizer may also be referred to a cartomizer or an atomizer, but is not limited thereto.

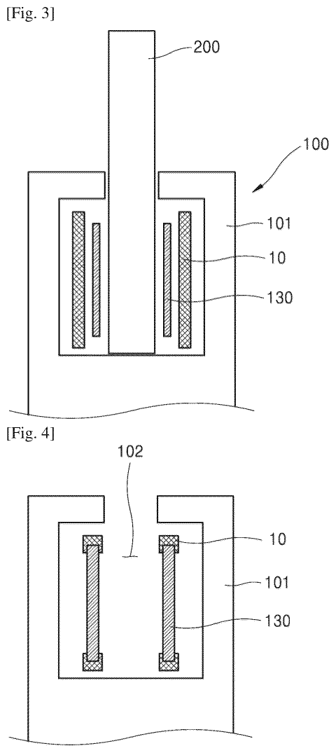

FIG. 3 is a cross-sectional view of an example in which the aerosol generating article 200 is inserted into the aerosol generating device 100 according to the embodiment shown in FIG. 2.

Referring to FIG. 3, the insulating material 10 may be arranged at the outside of the heater 130 and may prevent the heat generated from the heater 130 from being transferred to the outside of the accommodating space 102. The insulating material 10 may be arranged between the outer housing 101 and the heater 130 and prevent heat loss of the aerosol generating device 100. Although FIG. 3 illustrates an example in which the insulating material 10 having a tube shape is arranged at the outside the heater 130 having a tube shape, the embodiment is not limited thereto. The insulating material 10 may be applied without limitation as long as being capable of preventing the heat generated from the heater 130 from being transferred to the outside of the accommodating space 102.

The insulating material 10 may have the heat generated by the heater 130 concentrated onto the aerosol generating article 200, to thereby improve heating efficiency of the heater 130 and sense of smoking provided by the aerosol generating device 200. In addition, the insulating material 10 may reduce a pre-heating time and power consumption of the aerosol generating device 100.

The insulating material 10 may be arranged between the heater 130 and the outer housing 101 of the aerosol generating device 100, and the heater 130 and the insulating material 10 may be arranged apart from each other. As an air layer is formed in a space between the heater 130 and the insulating material 10, a performance of preventing transfer of the heat generated by the heater 130 may be improved. In general, when the heater 130 has a cylinder shape surrounding the outer surface of the aerosol generating article 200, as a wide area of the heater 130 is arranged adjacent to the outer housing 101 of the aerosol generating device 100, the heat generated by the heater 130 may be easily delivered to the outside of the aerosol generating device 100, causing the user to have a sense of heat or having undesirable influences on other components. According to an embodiment, as the heater 130 and the insulating material 10 are apart from each other, the heat generated by the heater 130 is not directly delivered to the insulating material 10, and accordingly the insulation performance may be further improved.

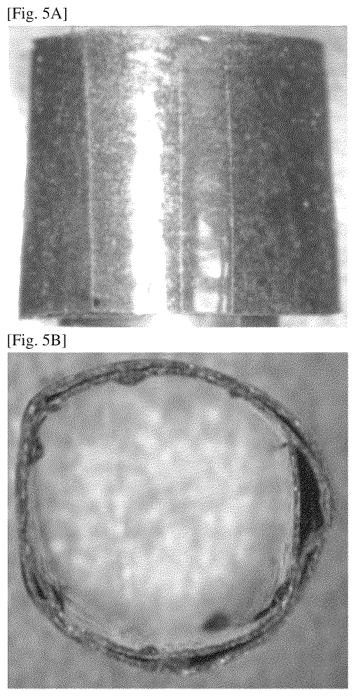

FIG. 4 is a schematic cross-sectional view of an example of the aerosol generating device 100 including the insulating material 10 for the aerosol generating device according to another embodiment.

Referring to FIG. 4, the insulating material 10 may contact an end portion in the longitudinal direction of the heater 130. As shown in FIG. 4, the insulating material 10 may have a ring shape, and may contact an end portion in the longitudinal direction of the heater 130 having the tube shape, to thereby prevent the end portion of the heater 130 from being exposed to the outside.

The end portion of the heater 130 may be supported by other components in the aerosol generating device 100 such that the heater 130 maintains the position thereof in the aerosol generating device 100. The insulating material 10 may be arranged between the end portion of the heater 130 and the component configured to support the end portion of the heater 130 and may prevent the heat being transferred from the heater 130 to the component configured to support the end portion of the heater 130.

Here, the insulating material 10 in contact with the end portion of the heater 130 may include a porous structure including the insulating fiber. Based on flexibility, the insulating material 10 including the insulating fiber may effectively maintain the contact with the end portion of the heater 130 having a small area. In addition, the waterproof film 12 of the insulating material 10 may be formed by coating the insulation sheet 11 with the paint (i.e., a coating material) having adhesion force or heat resistance. When the waterproof film 12 is formed by coating the insulation sheet 11 with the paint, the waterproof film 12 may be formed in a small thickness, and accordingly, flexibility of the insulating material 10 may be further improved.

### Embodiment 1. Manufacture of an Insulating Material for the Aerosol Generating Device (a Single-Surface Waterproof Film, a Thickness of 0.170 mm, an Inner Diameter of 9.0 mm)

A sheet-type insulating material for an aerosol generating device in a thickness of 0.170 mm is manufactured by coating a surface of polyimide paper having a thickness of 0.150 mm with a polyimide varnish (a waterproof film), and drying the varnish for ten minutes under a temperature of 130° C. The sheet-type insulating material for the aerosol generating device is wound once by a tube having a diameter of 9.0 mm and fixed with an adhesive.

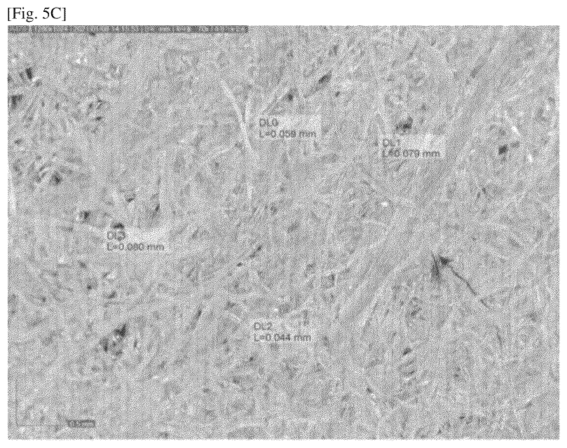

FIGS. 5A and 5B are diagrams of an image of an insulating material of an aerosol generating device, manufactured according to Embodiment 1. FIG. 5A is an image of an outer surface the insulating material of the aerosol generating device manufactured according to Embodiment 1, with a viewing direction perpendicular to a longitudinal direction; and FIG. 5B is an image of the insulating material for the aerosol generating device with a viewing direction parallel to the longitudinal direction. In addition, FIG. 5C is a microscope image of the outer surface of the insulating material for the aerosol generating device manufactured according to Embodiment 1.

Referring to FIGS. 5A to 5C, it is found that the insulating material for the aerosol generating device has a porous structure including polyimide fibers stacked together, and has extraordinary flexibility.

### Embodiment 2. Manufacture of an Insulating Material for the Aerosol Generating Device (a Double-Surface Waterproof Film, a Thickness of 0.200 mm, an Inner Diameter of 9.0 mm)

A tube-type insulating material for an aerosol generating device is manufactured in the same manner as Embodiment 1, except that the sheet-type insulating material for the aerosol generating device having a thickness of 0.200 mm is manufactured by coating two surfaces of polyimide paper having a thickness of 0.150 mm with a polyimide varnish.

### Embodiment 3. Manufacture of an Insulating Material for the Aerosol Generating Device (a Double-Surface Waterproof Film, a Thickness of 0.400 mm, an Inner Diameter of 9.0 mm

A tube-type insulating material for an aerosol generating device is manufactured in the same manner as Embodiment 1, except that the sheet-type insulating material for the aerosol generating device having a thickness of 0.200 mm, which is manufactured by coating two surfaces of polyimide paper having a thickness of 0.150 mm with a polyimide varnish, is wound twice with a tube having a diameter of 9.0 mm.

### Embodiment 4. Manufacture of an Insulating Material for the Aerosol Generating Device (a Double-Surface Waterproof Film, a Thickness of 0.200 mm, an Inner Diameter of 9.2 mm)

A tube-type insulating material for an aerosol generating device is manufactured in the same manner as Embodiment 1, except that the sheet-type insulating material for the aerosol generating device having a thickness of 0.200 mm, which is manufactured by coating two surfaces of polyimide paper having a thickness of 0.150 mm with a polyimide varnish, is manufactured into a tube having a diameter of 9.2 mm.

### Embodiment 5. Manufacture of an Insulating Material for the Aerosol Generating Device (a Double-Surface Waterproof Film, a Thickness of 0.400 mm, an Inner Diameter of 9.2 mm)

A tube-type insulating material for an aerosol generating device is manufactured in the same manner as Embodiment 1, except that the sheet-type insulating material for the aerosol generating device having a thickness of 0.200 mm, which is manufactured by coating two surfaces of polyimide paper having a thickness of 0.150 mm with a polyimide varnish, is wound twice with a tube having a diameter of 9.2 mm.

### Experiment 1. Measuring Insulation Effect of the Insulating Material for the Aerosol Generating Device

An electric resistance tube-type film heater (0.700±0.035Ω is mount on an inner surface of the tube-type insulating material for the aerosol generating device manufactured according to Embodiments 1 and 2, and a stainless use steel (SUS) pipe is mounted on an inner surface of the film heater, to thereby manufacture a module for measuring insulation effect. A voltage of 2.5 V is applied to the tube-type film heater to heat the tube-type film heater to an average saturation temperature of 290° C. and changes in the temperature of the SUS pipe is measured according to time.

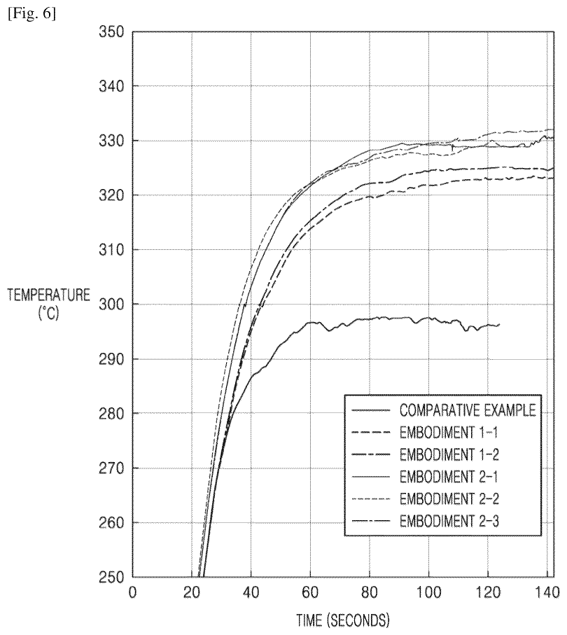

FIG. 6 is a graph of a result of measuring temperature changes over time measured by Experiment 1. The graph shown in FIG. 6 is marked according to types of the insulating materials for the aerosol generating device used in the module for measuring insulation effect. Comparative Example indicates a module in which the insulating material for the aerosol generating device is not used. The measurement in Embodiment 1 is performed twice and the measurements are respectively marked as Embodiment 1-1 and Embodiment 1-2, and the measurement in Embodiment 2 is performed three times and the measurements are respectively marked as Embodiment 2-1, Embodiment 2-2, and Embodiment 2-3.

Referring to FIG. 6, a saturation temperature in the Comparative Example is measured as about 298° C., while the average saturation temperature in Embodiment 1 is measured as about 325° C. and the average saturation temperature in Embodiment 2 is measured as about 330° C. Accordingly, it is found that the average saturation temperatures of the Embodiments including the insulating material is higher than the Comparative Example that does not include the insulating material, is, resulting in extraordinary insulating effect. In addition, it is found that the Embodiment 1, in which only one surface of the insulating material is coated with the waterproof film, and the Embodiment 2, in which two surfaces of the insulating material are coated with the waterproof film, have a similar level of insulating effect.

### Experiment 2. Comparing Insulation Performances According to Thickness of the Insulating Material

Except using the tube-type insulating material for the aerosol generating device manufactured according to Embodiments 2 and 3, the experiment is performed in the same manner as Experiment 1.

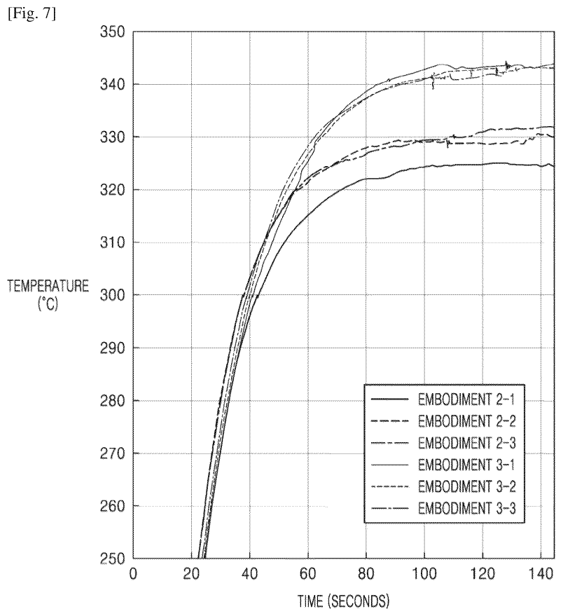

FIG. 7 is a graph of a result of measuring temperature changes according to times measured by Experiment 2. Like in Experiment 1, the graph shown in FIG. 7 is marked according to types of the insulating materials for the aerosol generating device used in the module for measuring insulation effect. The measurement of Embodiment 2 is performed three times and the measurements are respectively marked as Embodiment 2-1, Embodiment 2-2, and Embodiment 2-3, and the measurement of Embodiment 3 is also performed three times and the measurements are respectively marked as Embodiment 3-1. Embodiment 3-2, and Embodiment 3-3.

Referring to FIG. 7, the average saturation temperature of Embodiment 2 is measured as about 330° C., while the average saturation temperature of Embodiment 3 is measured as about 343° C. Accordingly, it is found that the insulation performance is improved with the increase in the thickness of the insulating material.

### Experiment 3. Comparing Insulation Performances According to an Inner Diameter of the Insulating Material

Except using the tube-type insulating material for the aerosol generating device manufactured according to Embodiments 2 to 5, the experiment is performed in the same manner as Experiment 1.

FIG. 8 is a graph of a result of measuring temperature changes according to times measured by Experiment 3. Like in Experiment 1, the graph shown in FIG. 8 is marked according to types of the insulating materials for the aerosol generating device used in the module for measuring insulation effect.

Referring to FIG. 8, the average saturation temperature of Embodiment 3 is measured as about 330° C., an average saturation temperature of Embodiment 4 is measured as about 320° C., and an average saturation temperature of Embodiment 5 is measured as about 336° C. Accordingly, it is found that the insulation effect is decreased according to the increase in the diameter of the insulating material.

### Experiment 4. Experiment on Waterproof Performance of the Insulating Material

The waterproof performance of the insulating material is confirmed by dropping glycerin droplets on the surface of the insulating material for the aerosol generating device manufactured according to Embodiment 1.

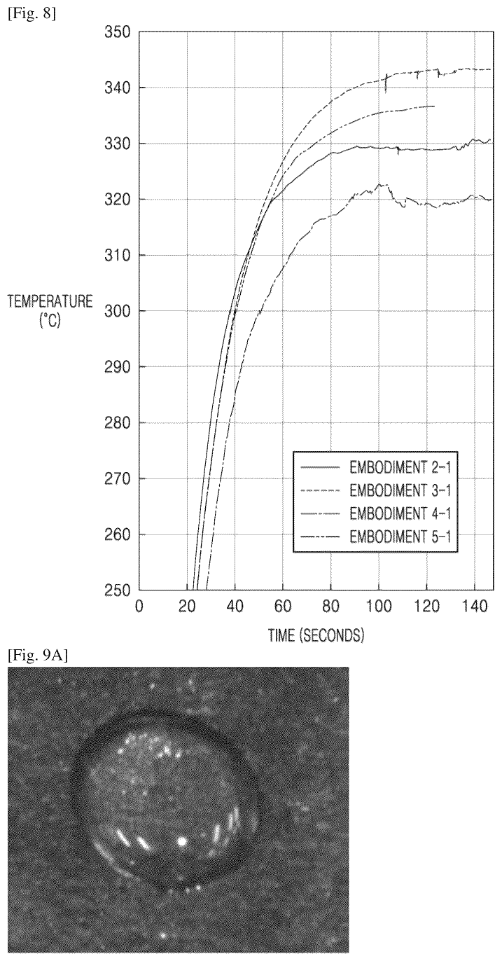

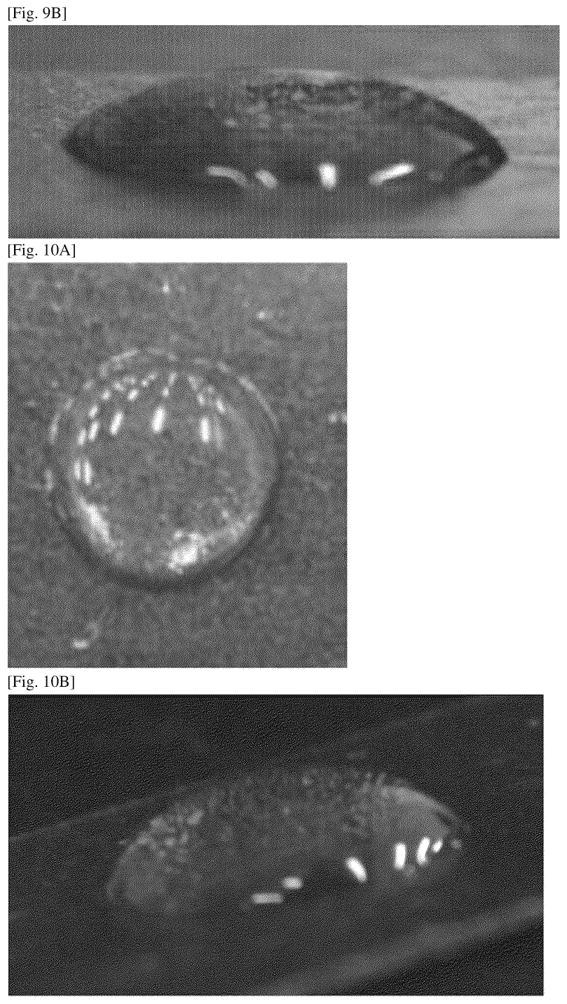

FIGS. 9A and 9B are images taken right after the glycerin droplets are dropped on the surface of the insulating material according to Experiment 4, and FIGS. 10A and 10B are images taken an hour after the glycerin droplets are dropped on the surface of the insulating material.

Referring to FIGS. 9A to 10B, it is found that the glycerin droplets dropped on the surface on the insulating material are not absorbed into the insulating material and maintain their own shapes. Therefore, it is found that the insulating material has extraordinary waterproof performance.

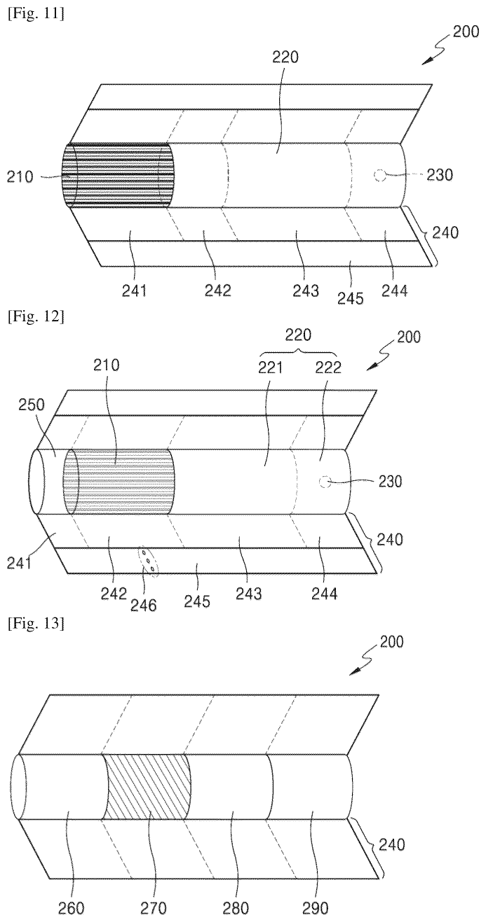

Hereinafter, examples of the aerosol generating articles that may be used in the aerosol generating device according to an embodiment will be described with reference to FIGS. 11 to 13.

FIG. 11 is a schematic diagram of an example of the aerosol generating article 200.

Referring to FIG. 11, the aerosol generating article 200 may include a tobacco rod 210 and a filter rod 220. FIG. 11 illustrates that the filter rod 220 includes a single segment. However, the filter rod 220 is not limited thereto. In other words, the filter rod 220 may include a plurality of segments. For example, the filter rod 220 may include a first segment configured to cool an aerosol and a second segment configured to filter a certain component included in the aerosol. Also, as necessary, the filter rod 220 may further include at least one segment configured to perform other functions.

The aerosol generating article 200 may be packaged using at least one wrapper 240. The wrapper 240 may have at least one hole through which external air may be introduced or internal air may be discharged. For example, the aerosol generating article 200 may be packaged by one wrapper 240. As another example, the aerosol generating article 200 may be doubly packaged by two or more wrappers 240. For example, the tobacco rod 210 may be packaged by a first wrapper 241, and the filter rod 220 may be packaged by wrappers 242, 243, 244. Also, the entire aerosol generating article 200 may be re-packaged by another single wrapper 245. When the filter rod 220 includes a plurality of segments, each segment may be packaged by wrappers 242, 243, 244.

The tobacco rod 210 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet. Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transmitted to the tobacco rod 210, and thus, the heat conductivity applied to the tobacco rod may be increased and taste of the tobacco may be improved. Also, the heat conductive material surrounding the tobacco rod 210 may function as a susceptor heated by the induction heater. Here, although not illustrated in the drawings, the tobacco rod 210 may further include an additional susceptor, in addition to the heat conductive material surrounding the tobacco rod 210.

The filter rod 220 may include a cellulose acetate filter. Shapes of the filter rod 220 are not limited. For example, the filter rod 220 may include a cylinder-type rod or a tube-type rod having a hollow inside. Also, the filter rod 220 may include a recess-type rod. When the filter rod 220 includes a plurality of segments, at least one of the plurality of segments may have a different shape.

The filter rod 220 may be formed to generate flavors. For example, a flavoring liquid may be injected onto the filter rod 220, or an additional fiber coated with a flavoring liquid may be inserted into the filter rod 220.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

When the filter rod 220 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

FIG. 12 is a schematic diagram of another example of the aerosol generating article 200.

Referring to FIG. 12, the aerosol generating article 200 may further include a front-end plug 250. The front-end plug 250 may be located on one side of the tobacco rod 210 which is opposite to the filter rod 220. The front-end plug 250 may prevent the tobacco rod 210 from being detached outwards and prevent the liquefied aerosol from flowing from the tobacco rod 210 into the aerosol generating device, during smoking.

The filter rod 220 may include a first segment 221 and a second segment 222. Here, the first segment 221 may correspond to the first segment of the filter rod 220 of FIG. 4, and the second segment 222 may correspond to the second segment of the filter rod 220 of FIG. 4.

A diameter and a total length of the aerosol generating article 200 may correspond to a diameter and a total length of the aerosol generating article 200 of FIG. 11. For example, the length of The front-end plug 250 is about 7 mm, the length of the tobacco rod 210 is about 15 mm, the length of the first segment 221 is about 12 mm, and the length of the second segment 222 is about 14 mm, but it is not limited thereto.

The aerosol generating article 200 may be packaged using at least one wrapper 240. The wrapper 240 may have at least one hole through which external air may be introduced or internal air may be discharged. For example, the front end plug 250 may be packaged by a first wrapper 241, the tobacco rod 210 may be packaged by a second wrapper 242, the first segment 221 may be packaged by a third wrapper 243, and the second segment 222 may be packaged by a fourth wrapper 244. Further, the entire aerosol generating article 200 may be repackaged by a fifth wrapper 245.

In addition, at least one perforation 246 may be formed in the fifth wrapper 245. For example, the perforation 246 may be formed in a region surrounding the tobacco rod 210, but is not limited thereto. The perforation 246 may serve to transfer heat generated by the heater to the inside of the tobacco rod 210.

In addition, at least one capsule 230 may be included in the second segment 222. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

FIG. 13 is a schematic diagram of another example of the aerosol generating article 200.

Referring to FIG. 13, the aerosol generating article 200 may include a first portion 260, a second portion 270, a third portion 280, and a fourth portion 290. More particularly, the first portion 260, the second portion 270, the third portion 280, and the fourth portion 290 may include an aerosol generating element, a tobacco element, a cooling element, and a filter element, respectively. For example, the first portion 260 may include an aerosol generating material, the second portion 270 may include a tobacco material and a moisturizer, the third portion 280 may cool an airflow passing through the first portion 260 and the second portion 270, and the fourth portion 290 may include a filter material.

Referring to FIG. 13, the first portion 260, the second portion 270, the third portion 280, and the fourth portion 290 may be sequentially arranged with reference to the longitudinal direction of the aerosol generating article 200. Here, the longitudinal direction of the aerosol generating article 200 may be a direction in which a length of the aerosol generating article 200 increases. For example, the longitudinal direction of the aerosol generating article 200 may be a direction from the first portion 260 to the fourth portion 290. Accordingly, the aerosol generated from at least one of the first portion 260 and the second portion 270 may sequentially pass through the first portion 260, the second portion 270, the third portion 280, and the fourth portion 290 and form an airflow, and thus, the user may puff the aerosol from the fourth portion 290.

The first portion 260 may include the aerosol generating element. In addition, the first portion 260 may include other additives such as a flavoring agent, a wetting agent, and/or organic acid, and may also include a flavoring liquid such as menthol or moisturizer. Here, the aerosol generating element may include, for example, at least one of glycerin, propylene glycol, ethylene glycol, dipropylene glycol, diethylene glycol, triethylene glycol, tetraethylene glycol, and oleyl alcohol.

The first portion 260 may include a crimped sheet, and the aerosol generating element may be included in the first region, in the state of being impregnated into the crimped sheet. In addition, other additives, such as the flavoring agent, the wetting agent and/or organic acid, and the flavoring liquid may be included in the first portion 260, in the state of being absorbed by the crimped sheet.

The crimped sheet may include a sheet including a polymer material. For example, the polymer material may include at least one of paper, cellulose acetate, lyocell, and polylactic acid. For example, the crimped sheet may include a paper sheet that does not generate an odor due to heat even when heated to a high temperature. However, the embodiment is not limited thereto.

The first portion 260 may extend from an end portion of the aerosol generating article 200 to a point of from about 7 mm to about 20 mm, and the second portion 270 may extend from the point at which the first portion 260 ends to a point from about 7 mm to about 20 mm. However, the extension is not limited to the aforementioned numerical range, and lengths in which the first portion 260 and the second portion 270 respectively extends may be appropriately adjusted in a range which may be easily modified by those of ordinary skill in the art.

The second portion 270 may include the tobacco material. The tobacco element may include a specific type of tobacco material. For example, the tobacco element may have the form of tobacco cut fillers, tobacco particles, a tobacco sheet, tobacco beads, tobacco granules, tobacco powder, or a tobacco extract. In addition, the tobacco material may include, for example, at least one of tobacco leaves, tobacco rod, expanded tobacco, cut tobacco, reconstituted tobacco leaves, and reconstituted tobacco.

The third portion 280 may cool the air flow passing through the first portion 260 and the second portion 270. The third portion 280 may be manufactured from a polymer material or a bio-degradable polymer material, and may have a cooling function. For example, the third portion 280 may include a polylactic acid (PLA) fiber, but the material for forming the third portion 280 is not limited thereto. In some embodiments, the third portion 280 may include a cellulose acetate filter having a plurality of holes. However, the third portion 280 is not limited to the aforementioned example, and may include any material capable of cooling the aerosol. For example, the third portion 280 may include a tube filter or a paper tube filter including hollows.

The fourth portion 290 may include the filter material. For example, the fourth portion 290 may include a cellulose acetate filter. A shape of the fourth portion 290 is not limited. For example, the fourth portion 290 may include a circle type rod, and may also include a tube type rod including a hollow therein. In addition, the fourth portion 290 may also include a recess type rod. When the fourth portion 290 includes a plurality of segments, at least one of the plurality of segments may be manufactured into a different shape.

The fourth portion 290 may be manufactured to generate flavors. For example, a flavoring liquid may be sprayed to the fourth portion 290, and a fiber coated with the flavoring agent may be inserted into the fourth portion 290.

The aerosol generating article 200 include a wrapper 240 packaging at least a portion of the first portion 260 to the fourth portion 290. In addition, the aerosol generating article 200 may include the wrapper 240 completely packaging the first portion 260 to the fourth portion 290. The wrapper 240 may be at an outermost profile of the aerosol generating article 200. The wrapper 240 may include a single wrapper, but may also include a combination of a plurality of wrappers.

For example, the first portion 260 of the aerosol generating article 200 includes a crimped sheet including the aerosol generating material, the second portion 270 may include reconstituted tobacco leaves as the tobacco material and glycerin as the moisturizer, the third portion 280 may include a paper tube, and the fourth portion 290 may include a cellulose acetate fiber, but the embodiment is not necessarily limited thereto.

Those of ordinary skill in the art related to the present embodiments may understand that various changes in form and details can be made therein without departing from the scope of the characteristics described above. Therefore, the disclosed methods should be considered in a descriptive point of view, not a restrictive point of view. The scope of the present disclosure is defined by the appended claims rather than by the foregoing description, and all differences within the scope of equivalents thereof should be construed as being included in the present disclosure.

1. An insulating material for an aerosol generating device, the insulating material comprising:
an insulation sheet; and
a waterproof film arranged on at least one surface of the insulation sheet.

2. The insulating material of claim 1, wherein the insulation sheet has a porous structure formed by insulation fibers.

3. The insulating material of claim 1, wherein the insulation sheet comprises a polyimide fiber.

4. The insulating material of claim 1, wherein a thickness of the insulation sheet is about 0.05 mm to about 1 mm.

5. The insulating material of claim 1,
wherein the waterproof film comprises a first waterproof film arranged on a surface of the insulation sheet and a second waterproof film arranged on another surface of the insulation sheet, and
the first waterproof film and the second waterproof film are attached to each other such that the insulation sheet is not exposed to outside.

6. The insulating material of claim 1, wherein the waterproof film comprises at least one material selected from the group consisting of polyimide (PI), polyether ether ketone (PEEK), polyamide imide (PAT), polyphenylene sulfide (PPS), polyphenyl sulfone (PPSU), polysulfone (PSU), polyether sulfone (PES), polytetherimide (PEI), polytetrafluoroethylene (PTFE), and polyvinylidenefluoride (PVDF).

7. An aerosol generating device comprising
an accommodating space for accommodating an aerosol generating article,
a heater configured to heat the aerosol generating article accommodated in the accommodating space; and
an insulating material arranged outside the heater and configured to prevent heat generated from the heater from being transferred to outside of the accommodating space,
wherein the insulating material comprises an insulation sheet and a waterproof film arranged on at least one surface of the insulation sheet.

8. The aerosol generating device of claim 7, wherein the insulating material contacts an end portion of the heater in a longitudinal direction of the heater.

9. The aerosol generating device of claim 7,
wherein the insulating material is arranged between the heater and an outer housing of the aerosol generating device, and
the heater and the insulating material are arranged apart from each other.

10. The aerosol generating device of claim 7, wherein the insulation sheet has a porous structure formed by insulating fibers.

11. The aerosol generating device of claim 7, wherein the insulation sheet comprises a polyimide fiber.

12. The aerosol generating device of claim 7, wherein a thickness of the insulation sheet is about 0.05 mm to about 1 mm.

13. The aerosol generating device of claim 7,
further comprising a first waterproof film arranged on a surface of the insulation sheet and a second waterproof film arranged on another surface of the insulation sheet,
wherein the first waterproof film and the second waterproof film are attached to each other such that the insulation sheet is not exposed to outside.

14. The aerosol generating device of claim 13, wherein the first waterproof film and the second waterproof film comprises at least one material selected from the group consisting of polyimide (PI), polyether ether ketone (PEEK), polyamide imide (PAI), polyphenylene sulfide (PPS), polyphenylsulfone (PPSU), polysulfone (PSU), polyether sulfone (PES), polyether imide (PET), polytetrafluoroethylene (PTFE), and polyvinylidenefluoride (PVDF).
